(19) United States
(12) Patent Application Publication
(10) Pub. No.: US 2008/0024282 A1
(43) Pub. Date: Jan. 31, 2008

(54) Tsunami alarm system

(76) Inventors: Wolfram Johannes Bernd Reiners, Konstanz (DE); Eduard Heindl, Tubingen (DE)

Correspondence Address: SHLESINGER, ARKWRIGHT & GARVEY LLP, SUITE 600, 1420 KING STREET, ALEXANDRIA, VA, 22314, US

(21) Appl. No.: 11/878,637

(22) Filed: Jul. 25, 2007

Related U.S. Application Data
(63) Continuation of application No. PCT/EP06/00632, filed on Jan. 25, 2006.

(30) Foreign Application Priority Data
Jan. 25, 2005 (DE) 10 2005 003 532.9

(51) Int. Cl. G08B 27/00; H04M 11/04

(52) U.S. Cl. 340/286.01; 455/404.1

(57) ABSTRACT

The invention relates to a tsunami alarm system that integrates information from seismic measurement stations or tsunami warning stations by applying the data collection procedures of the warning detection and consolidation station 30. In conjunction with the warning assessment and alarm station 40 the system decides by its alarm logic, whether an alarm is raised. Alarms are distributed by the distribution list manager 50 via the mobile telephony network operators 60 to the mobile devices and mobile telephones 70 of the participating people. The pervasion application 80, which resides on the mobile telephone or mobile device, increases the likelihood that alarms are not overheard and hence get noticed. In this way the invention enables people to take preventive action many minutes before the devastating tsunami arrives. Further, the invention relates to a method for providing tsunami warning messages and a computer program for processing said method.

### RELATED APPLICATIONS

This is a continuation of International Application No. PCT/EP2006/000632, filed Jan. 25, 2006, which claims the priority benefit of German Patent Application No. 10 2005 003 532.9, filed Jan. 25, 2005, incorporated herein by reference.

### FIELD OF THE INVENTION

This invention relates to a tsunami alarm or alert system, a method for providing tsunami warning messages and a computer program for processing the method on a computerized system, particularly on a computerized telecommunication system. More particularly this invention relates to a tsunami alarm system for people from the hazards as originating from tsunamis or a method of effectively warning people about a tsunami.

### BACKGROUND OF THE INVENTION

The hazards that originate from tsunamis have been recognised for some time. Newspaper reports about undersea earthquakes and movies about meteor-inflicted tsunamis have contributed to public awareness of the threat. Early warning systems were constructed and deployed for instance in the Pacific Rim. Many areas in the world, however, are not covered by such traditional warning systems. At the latest in December 2004, when a tsunami has devastated wide areas bordering to the Indian Ocean, the extensive media coverage has elevated the sheer possibility, the effects and the dangers of a tsunami into global public consciousness. In the memory and perception of tourists and holidaymakers seashore sites may forever bear tsunami-related dangers, resulting in the desire for effective, reliable and easy-to-use tsunami alarm systems.

It is an object of the present invention to provide means and a method to overcome the above described problem.

### SUMMARY OF THE INVENTION

According to the invention, there is provided a tsunami alarm system in the form of a data processing system, which includes a warning detection station which utilising Internet technologies such as agent technologies to seek information about the likely occurrence of a tsunami on the Internet. If such a warning is detected, typically on a web site, a warning consolidation procedure is triggered. The consolidation may include a pre-alarm to the supervisor of the alarm system and the attempt to verify the original warning, or it may include an automatic assessment procedure consisting of the attempt to verify the warning on other Internet sites for which the system is pre-configured and which are deemed to be relevant. The system can be parameterised as to which assessment procedure it will give priority, the manual or the automatic, or even more complex decision rules may be applied, such as a rule like
“Wait for 15 minutes for the supervisor and the final supervisor's decision. During that time, seek information actively from the set of the other pre-configured Internet sites. If the warning can be replicated on at least 1 more site, then execute the alarm. If the supervisor has not logged into the system after 15 minutes have lapsed and no confirmation has been detected on the other pre-configured web sites, then raise the alarm on the grounds of the single warning.”

Another option for the rule could be like the above, with the last portion of the last sentence reading
“[. . . ] pre-configured web sites, then repeat the procedure.”

If and as soon as the alarm is raised, a distribution list manager sends an alarm message together with a description of the region of the tsunami hazard via a mobile telephony network or a mobile data network to all subscribers of the alarm list. These alarm messages are received on the mobile devices or mobile telephones of the respective network subscribers. An application on the devices or telephones that has previously been installed thereon ensures that the alarm signal is pervasive for the person who receives the alarm. This pervasion application or pervasion unit causes for instance that a mobile phone or telephone in the mute mode nevertheless rings audibly upon reception of the alarm message. Also, this unit may cause a telephone to always use the loudest ring option. In addition a specifically alerting type of tone may be used, like high-pitched beeping.

During a call, the mobile phone or telephone may interrupt the call and switch to the tsunami message.

In this way the participants at the alarm system will reliably receive an alarm, as and when a dangerous tsunami is or may be evoked. The alarm together with the description of the region of the tsunami enables the recipient to accurately decide whether the alarm bears any relevance for him or herself, or for others he or she may want to inform. Remedial action, if any, can be taken, likely many minutes before the hazardous event itself takes place.

Even when a false or irrelevant alarm is received, this may re-assure the user from time to time that the alarm system is still properly functioning, with its vital and ubiquitous warning mechanism lending peace of mind at seashore sites.

### BRIEF DESCRIPTION OF THE DRAWINGS

The invention is now described by way of example only and with reference to the accompanying drawings.

FIG. 1 shows the architecture of the tsunami alarm generation unit, in accordance with the invention.

FIG. 2 shows the architecture of the tsunami alarm execution unit, also in accordance with the invention.

FIG. 3 shows the tsunami alarm pervasion unit; it also shows an example of the effect that the pervasion application is causing on the mobile device or telephone, after the alarm message has been received in accordance with the invention.

### DETAILED DESCRIPTION OF THE INVENTION

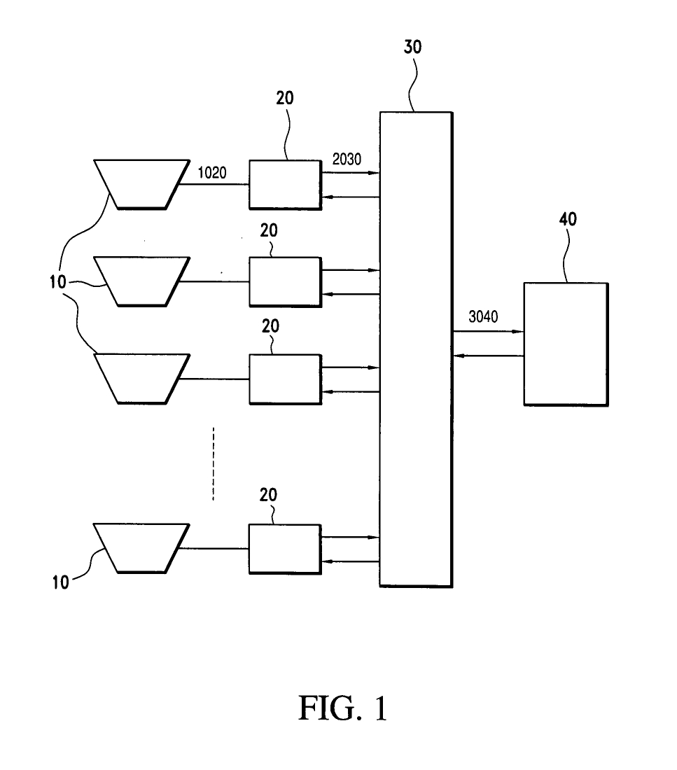

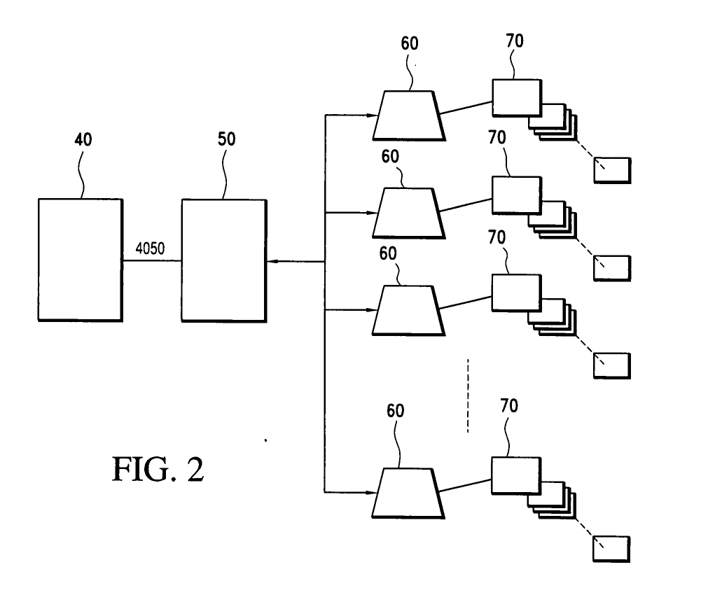

Referring to FIGS. 1 to 3 showing the invention in a possible embodiment, the invention comprises a warning detection and consolidation station 30. Data collection according to the invention is done via actions 2030 which the system executes automatically in pre-configured intervals and on pre-configured web sites 20 that the system deems relevant. Any web site 20 serving as reporting facilities for reputable seismic measuring stations or tsunami assessment stations 10, such as e.g. the Deep-ocean Assessment and Reporting of Tsunami (DART) devices of NOAA, the National Oceanic and Atmospheric Administration as operated by the U.S. Department of Commerce, may become categorised as relevant.

Warning procedures may initiate from seismic measuring stations or tsunami assessment stations 10 which employ seismic sensors, submarine pressure and velocity sensors and satellite radar data. Additional early warning information from geophones, measurement of the complex electric resistance, change in radon and other gas concentrations are collected for validation and additional calculation of the area of concern. This data is pre-processed by different standard procedures, including neural network and support vector machine algorithm, and summarised by the tsunami reporting stations 20—typically a web site.

Thus, the tsunami warning information is stored in a remote accessible dataspace like the Internet. Technically, the data collection actions 2030 are implemented by intelligent agents data capturing. These agents connect on a regular basis to the dataspace and extract the relevant information. For this procedure, protocols such as HTML over HTTP are sufficient. A more suitable protocol may be SOAP as designed by w3c.org. For rapid exchange of information other well-known protocols within the TCP/IP family, as SMTP for active distribution of the information, might be used.

The data collection activities 2030 can be configured for the type of data collection to be executed, and for frequency. Suitable may be for instance a 1 minute interval. As an alternative, the data collection can be carried out continuously. If the warning detection and consolidation station 30 detects a tsunami warning upon its connection (visit) to any one of the selected tsunami reporting stations 20, a preliminary warning message is sent to the warning assessment and alarm station 40. This station 40 contains the alarm logic. The alarm logic may contain a variety of complex rules, which determine as and when to raise an alarm. In addition, the warning assessment and alarm station 40 has interface processes 3040 with the warning detection and consolidation station 30. Next to the already mentioned preliminary warning message, the interface processes 3040 may contain instructions to cause the warning and consolidation station 30 to verify the warning from another one of the tsunami reporting stations, for the purpose to reduce the likelihood of false alarms.

The warning assessment and alarm station 40 can also raise a pre-alarm to the supervisor of the alarm system. This may serve to initialise an attempt to verify the original warning by the supervisor, for instance by manually checking the web sites of the various tsunami reporting stations. Typically, the supervisor will be able to raise the alarm manually, to raise a test alarm or even to suppress the raising of an alarm, despite of the preliminary warning message that has been triggered after a tsunami warning was automatically detected on a web site of a tsunami reporting station 20.

Other decision rules to configure 40 are possible. The chosen rule may serve to fine-tune the sensitivity of the entire alarm system, i.e. more sensitive, including a higher likelihood of false alarms, or less sensitive, reducing false alarms, but raising the risk of a tsunami without prior alarm. Typically, the system is tuned sensitive, as false alarms may still occur rarely, and should they happen these will serve the purpose to remind the user of the system and that the system is actually working and hence to re-assure the user of the shelter while being at the seaside.

For each alarm an assessment of the location of the tsunami and the affected region and countries is conducted and included into the alarm messages, either manually or automatically by means of the described processes and technologies for the data collection activities 2030. Test-alarms are also possible.

If the alarm is raised, either through the supervisor manually, or automatically in accordance with the decision rules as configured in the warning assessment and alarm station 40, the distribution list manager 50 hands over the telephone numbers or other contact details to the operators of a mobile telephony network 60 or any other network that connects mobile devices. The handover is executed automatically and in the standard formats as defined by the network operators 60.

The network operators send out the predefined alarm text or voice message to the selected mobile or standard telephones or mobile devices. A text message could use for instance the SMS format. Depending on the client-side setup at the client, a voice call with a computer-generated message may also be transmitted.

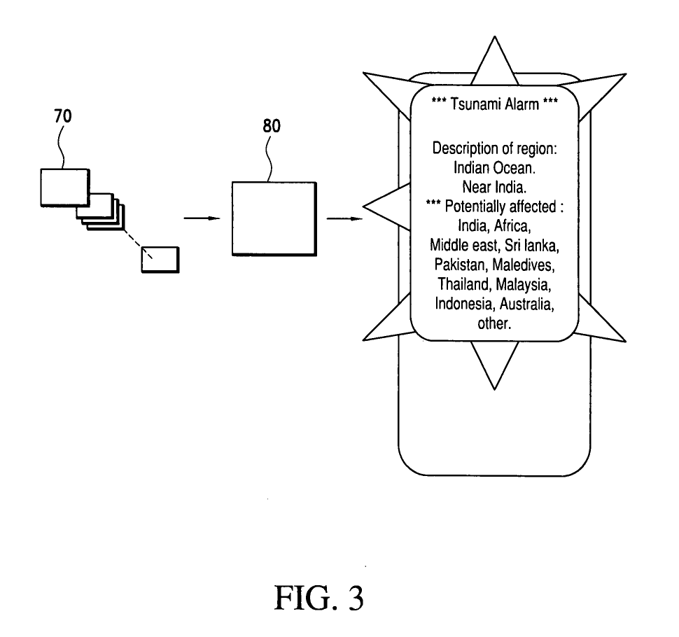

As indicated in FIG. 3, the mobile telephones or devices 70 carry a tsunami alarm pervasion application 80. The pervasion application 80 may be downloaded to the mobile device by the time when the owner of the device joins the tsunami alarm system. Download may be conducted via standard procedures, typically from a web site, and installation then takes place on the mobile telephone or device. Without the installation of the pervasion application 80, the alarm message will simply be received on the telephone as a standard SMS, and may therefore be missed, for instance at night times. The pervasion application 80, though, causes the telephone to execute a highly visible and audible alarm. This alarm will also happen with silent-switched phones (mute mode).

FIG. 3 also shows an exemplary alarm message as handed over to a mobile telephony network operator 60 and as displayed on a mobile device 70.

The inventors believe that the invention as illustrated provides an effective, reliable and easy-to-use tsunami alarm system. It can be built up rapidly as it selectively makes use of existing resources. Beneficiaries of the alarm system are people who live and travel near the seaside. All they need to do to feel secure is to carry a mobile telephone that has been equipped with the pervasion application 70.

The tsunami alarm system can also be extended to other hazards that incur infrequently and affect large regions.

We claim:

1. A tsunami alarm system for generating tsunami warning messages, comprising:
a warning detection and consolidation station for detecting and consolidating warning input data,
a warning assessment and alarm station for assessing the warning input data and generating warning output data therefrom, and
a distribution list managing station for distributing the warning output data.

2. The tsunami alarm system according to claim 1, wherein the warning input data is generated by seismic measuring stations or tsunami assessment stations.

3. The tsunami alarm system according to claim 1, wherein the warning input data is detected on pre-configured web sites which serve as reporting facilities of said seismic measuring stations or tsunami assessment stations.

4. The tsunami alarm system according to claim 1, wherein the warning output data is distributed via mobile network operators operating mobile networks which connect mobile devices.

5. The tsunami alarm system according to claim 4, wherein the mobile network operators operate a mobile telephone network and the mobile devices are mobile telephones.

6. The tsunami alarm system according to claim 4, wherein the warning output data is distributed as a warning message using the SMS format.

7. The tsunami alarm system according to claim 4, wherein a pervasion application is installed on the mobile device ensuring the perception of the warning output data.

8. A method for providing tsunami warning messages, comprising the steps of:
detecting and collecting warning input data using a warning detection and consolidation station,
consolidating the warning input data using said warning detection and consolidation station,
assessing the warning input data and generating warning output data therefrom using said warning assessment and alarm station and said warning detection and consolidation station,
distributing said warning output data using said distribution list managing station.

9. The method for providing tsunami warning messages according to claim 8, wherein the step of detecting and collecting warning input data is carried out continuously.

10. The method for providing tsunami warning messages according to claim 8, wherein the step of detecting and collecting warning input data is carried out in intervals.

11. The method for providing tsunami warning messages according to claim 8, wherein the warning input data is detected on and collected from web sites which serve as reporting facilities of said seismic measuring stations or tsunami assessment stations during the step of detecting and collecting warning input data.

12. The method for providing tsunami warning messages according to claim 8, wherein the step of assessing the warning input data and generating warning output data is carried out manually.

13. The method for providing tsunami warning messages according to claim 8, wherein the step of assessing the warning input data and generating warning output data therefrom is carried out automatically by said warning assessment and alarm station and said warning detection and consolidation station.

14. The method for providing tsunami warning messages according to claim 8, wherein the step of assessing the warning input data and generating warning output data is carried out following complex decision rules including automatic and/or manual processes.

15. The method for providing tsunami warning messages according to claim 8, wherein the step of distributing said warning output data is carried out by transmitting said warning output data via mobile network operators operating mobile networks which connect mobile devices.

16. The method for providing tsunami warning messages according to claim 15, wherein the mobile network operators operate a mobile telephone network and the mobile devices are mobile telephones.

17. The method for providing tsunami warning messages according to claim 15, wherein the warning output data is distributed as a warning message using the SA mS format.

18. The method for providing tsunami warning messages according to claim 15, further comprising a pervasion step carried out subsequently to the distribution step by a pervasion application installed on the mobile device ensuring the perception of the warning output data.

19. A computer program product with a computer-readable medium and a computer program stored on the computer-readable medium with program code which is suitable for carrying out a method according to claim 8 when the computer program is run on a computer.

20. A computer program with program coding means which are suitable for carrying out a method according to claim 8 when the computer program is run on a computer.

21. A computer-readable medium with a computers program stored thereon, the computer program comprising program code which is suitable for carrying out a method according to claim 8 when the computer program is run on a computer.

22. A mobile device capable of ensuring the perception of a warning message by an audible and/or visible alarm which is triggered upon reception of the warning message regardless of the state of the mobile device.

23. A mobile device according to claim 22, wherein the warning message is received in the SMS format.

24. A mobile device according to claim 22, wherein the mobile device is a mobile telephone.

25. A computer program product with a computer-readable medium and a computer program stored on the computer-readable medium with program code which is suitable for ensuring the perception of a warning message on a mobile device by an audible and/or visible alarm which is triggered upon reception of the warning message regardless of the state of the mobile device.

26. A computer program with program coding means which are suitable for ensuring the perception of a warning message on a mobile device by an audible and/or visible alarm which is triggered upon reception of the warning message regardless of the state of the mobile device.

27. A computer-readable medium with a computer program stored thereon, the computer program comprising program code which is suitable for ensuring the perception of a warning message on a mobile device by an audible and/or visible alarm which is triggered upon reception of the warning message regardless of the state of the mobile device.
